(19) United States
(12) Patent Application Publication
(10) Pub. No.: US 2018/0165980 A1
(43) Pub. Date: Jun. 14, 2018

(54) EDUCATIONAL ROBOT CONTROL DEVICE, STUDENT ROBOT, TEACHER ROBOT, LEARNING SUPPORT SYSTEM, AND ROBOT CONTROL METHOD

(71) Applicant: CASIO COMPUTER CO., LTD., Tokyo (JP)

(72) Inventors: Kaori Kadosawa, Tachikawa-shi (JP); Kazuhisa Nakamura, Akiruno-shi (JP); Akira Kashio, Musashino-shi (JP)

(21) Appl. No.: 15/785,861

(22) Filed: Oct. 17, 2017

(30) Foreign Application Priority Data
Dec. 8, 2016 (JP) 2016-238609

(51) Int. Cl. G09B 5/14; B25J 9/16; B25J 11/00

(52) U.S. Cl. CPC G09B 5/14; B25J 11/00; B25J 9/161

(57) ABSTRACT

A robot control device (a communication terminal) is a robot control device controlling a student robot playing a role of a student learning with a user and includes acquirer (a learning performance acquirer) that acquires an indicator presenting academic ability of the user, determiner (a student robot operation controller) that determines an operation of the student robot based on the indicator presenting the academic ability of the user acquired by the acquirer, and executor (the student robot operation controller) that makes the student robot execute the operation determined by the determiner.

### CROSS-REFERENCE TO RELATED APPLICATION

This application claims the benefit of Japanese Patent Application No. 2016-238609, filed on Dec. 8, 2016, the entire disclosure of which is incorporated by reference herein.

### FIELD

This application relates generally to a technique for improving learning effectiveness of a learner (user) using a robot.

### BACKGROUND

Techniques intended to support users in learning have been proposed. For example, Unexamined Japanese Patent Application Kokai Publication No. 2001-242780 discloses an information communication robot device with which the user can learn in an interactive fashion. The information communication robot device disclosed in Unexamined Japanese Patent Application Kokai Publication No. 2001-242780 performs bidirectional information input/output from/to the user by outputting output information using prestored educational information and feedback information corresponding to input information from the user.

### SUMMARY

According to an aspect of the present disclosure, a robot control device for controlling a student robot playing a role of a student learning with a user includes:

an acquirer that acquires an indicator presenting academic ability of the user;

a determiner that determines an operation of the student robot based on the indicator presenting the academic ability of the user acquired by the acquirer; and
an executor that makes the student robot execute the operation determined by the determiner.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE DRAWINGS

A more complete understanding of this application can be obtained when the following detailed description is considered in conjunction with the following drawings, in which:

FIG. 1 is an illustration showing the outline of the learning support system according to an embodiment of the present disclosure;

FIG. 2 is a block diagram showing an exemplary configuration of the teacher robot;

FIG. 3 is a block diagram showing an exemplary configuration of the student robot;

FIG. 4 is a block diagram showing an exemplary configuration of the communication terminal;

FIG. 5 is a chart showing an example of the learning history table;

FIG. 6A is a chart showing an example of the teacher robot operation mode setting table;

FIG. 6B is a chart showing an example of the teacher robot setting items—evaluation items association table;

FIG. 7A is a chart showing an example of the student robot operation mode setting table;

FIG. 7B is a chart showing an example of the student robot setting items—evaluation items association table;

FIG. 8 is a chart showing an example of the evaluation item score setting table;

FIG. 9A is an exemplary card image displayed on the display screen in presenting a question;

FIG. 9B is an exemplary card image displayed on the display screen in showing an answer;

FIG. 10 is a flowchart showing the process flow of the learning support control process; and

FIG. 11 is a flowchart showing the process flow of the operation control process.

### DETAILED DESCRIPTION

An embodiment of the present disclosure will be described below with reference to the drawings.

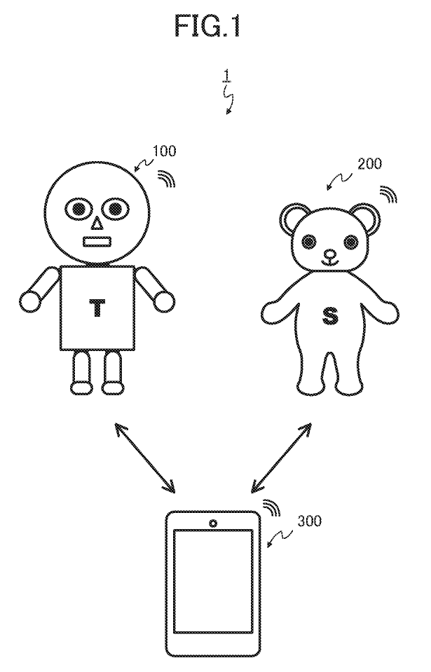

As shown in FIG. 1, a learning support system 1 according to an embodiment of the present disclosure comprises a robot playing the role of a teacher teaching a user (hereafter termed “teacher robot”) 100, a robot playing the role of a student taught by the teacher robot 100 with the user (hereafter termed “student robot”) 200, and a communication terminal 300. The communication terminal 300 is, as indicated by double-arrows, connected to the teacher robot 100 and the student robot 200 via short-range wireless communication so that mutual information transfer is available.

The teacher robot 100 and the student robot 200 each have a figure mimicking in appearance, for example, a stuffed animal or a character. In this embodiment, the teacher robot 100 has a figure mimicking in appearance a robot giving an impression of being serious to the user and the student robot 200 has a figure mimicking in appearance a teddy bear giving an impression of being gentle so that the user feels amicable. Here, these figures of the teacher robot 100 and the student robot 200 are given by way of example and either or both of the teacher robot 100 and the student robot 200 may be a computer.

The communication terminal 300 is a robot control device configured by, for example, a smartphone, a tablet-type communication terminal, a personal computer, or the like. The communication terminal 300 communicates with the teacher robot 100 and the student robot 200 and controls the teacher robot 100 and the student robot 200. The communication terminal 300 outputs sound or images based on the educational program to execute so as to provide learning support service to the user. The learning support service has any contents. This embodiment will be described using a case of learning English conversation by way of example, in which communication with the teacher robot 100 and the student robot 200 is likely to contribute to learning effectiveness of the user.

The configurations of the devices of the learning support system 1 will be described below.

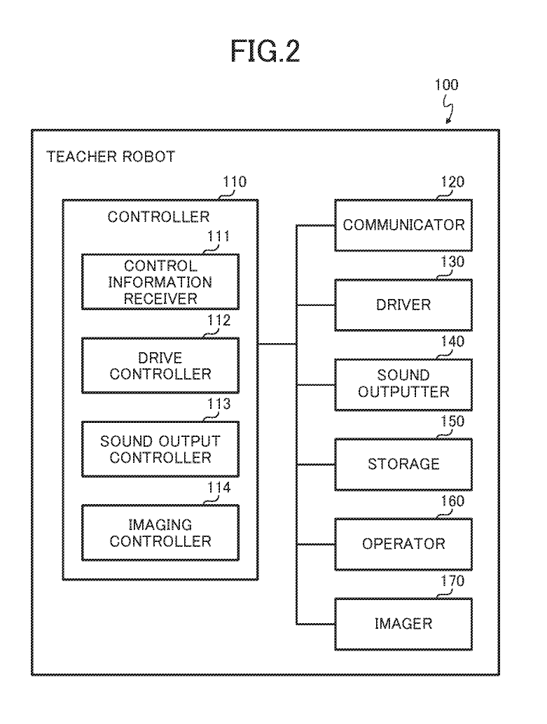

First, the configuration of the teacher robot 100 will be described. As shown in FIG. 2, the teacher robot 100 comprises a controller 110, a communicator 120, a driver 130, a sound outputter 140, a storage 150, an operator 160, and an imager 170.

The controller 110 controls the entire operation of the teacher robot 100. The controller 110 comprises, for example, a computer having a central processing unit (CPU), a read only memory (ROM), and a random access memory (RAM). The controller 110 controls the components of the teacher robot 100 by reading and executing on the RAM various programs stored in the ROM.

The functional configuration of the controller 110 of the teacher robot 100 is described here. The controller 110 functions as a control information receiver 111, a drive controller 112, a sound output controller 113, and an imaging controller 114.

The control information receiver 111 controls the communicator 120 to receive control information transmitted by the communication terminal 300 and receives the received control information.

The drive controller 112 generates drive signals based on the control information received by the control information receiver 111 and outputs the generated drive signals to the driver 130. As just stated, the drive controller 112 drives the driver 130 to make the teacher robot 100 execute various operations.

The sound output controller 113 generates sound signals based, for example, on the control information received by the control information receiver 111 and/or user operations such as sound volume adjustment received by the operator 160, and transmits the generated sound signals to the sound outputter 140. As just stated, the sound output controller 113 controls the sound and its volume output from the sound outputter 140.

The imaging controller 114 controls the imager 170 to capture a still image or a video and makes the communicator 120 transmit image data of the captured still image or video to the communication terminal 300. Here, the imaging controller 114 may be configured to determine the posture, the facial expression, the line of sight, and/or the like of the user based on the captured still image or video and transmit the determination result to the communication terminal 300.

The communicator 120 is a communication interface for performing data communication with the communication terminal 300 and comprises, for example, a radio frequency (RF) circuit, a base band (BB) circuit, a large scale integration (LSI), an antenna, and the like. The communicator 120 wireless-communicates with the communication terminal 300 via the antenna and transmits/receives various data. Here, the communicator 120 may be configured to wired-communicate with the communication terminal 300 using a universal serial bus (USB) cable, a high-definition multimedia interface (HDMI) cable, or the like.

The driver 130 comprises, for example, a gear, a motor, an actuator, and the like. The driver 130 drives movable parts of the teacher robot 100 according to the drive signals acquired from the controller 110. For example, the driver 130 controls the tilt of the neck of the teacher robot 100 so that the teacher robot 100 shakes his head vertically or horizontally or turns his head. Moreover, the driver 130 drives the teacher robot 100 to change the shape of the mouth, open/close the eyelids for blinking, or move over. With such operations and sound output described later, the teacher robot 100 is configured to express its feelings, line of sight, posture, and the like.

The sound outputter 140 comprises, for example, a speaker and the like. The sound outputter 140 outputs sound according to the sound signals acquired from the controller 110. Output sound is mainly sound relating to the teacher robot 100 teaching English conversation. Sound relating to teaching English conversation includes, for example, various kinds of sound proper for a teacher to utter in teaching English conversation such as questions to the user and the student robot 200, words urging to answer the questions (including speech leading to the answers), notification and/or explanation on correct/wrong answers, compliments for correct answers, and encouraging words for wrong answers.

The storage 150 stores various data necessary for the controller 110 to control the components of the teacher robot 100. The storage 150 comprises, for example, a nonvolatile storage such as a flash memory and a hard disc drive (HDD). The storage 150 stores, for example, sound data for the teacher robot 100 to output according to the control information received from the communication terminal 300 and the like in a given storage region.

The operator 160 comprises, for example, operation buttons, a touch panel, and the like. The operator 160 is, for example, an interface for receiving user operations such as power-on/off and output sound volume adjustment.

The imager 170 comprises, for example, a lens, an imaging element, and the like. The imager 170 captures an image of the entire body or a partial body (for example, the face) of the user and acquires image data of a still image or a video presenting the posture, the line of sight, the facial expression, and/or the like of the user.

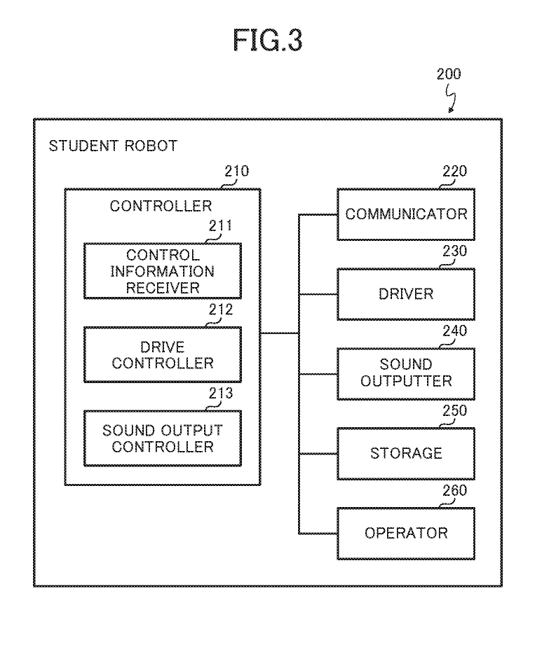

The configuration of the student robot 200 will be described next. As shown in FIG. 3, the student robot 200 comprises a controller 210, a communicator 220, a driver 230, a sound outputter 240, a storage 250, and an operator 260.

The controller 210 controls the entire operation of the student robot 200. The controller 210 comprises, for example, a computer having a CPU, a ROM, and a RAM. The controller 210 controls the components of the student robot 200 by reading and executing on the RAM various programs stored in the ROM.

The functional configuration of the controller 210 of the student robot 200 is described here. The controller 210 functions as a control information receiver 211, a drive controller 212, and a sound output controller 213.

The control information receiver 211 controls the communicator 220 to receive control information transmitted by the communication terminal 300 and receives the received control information.

The drive controller 212 generates drive signals based on the control information received by the control information receiver 211 and outputs the generated drive signals to the driver 230. As just stated, the drive controller 212 drives the driver 230 to make the student robot 200 execute various operations.

The sound output controller 213 generates sound signals based, for example, on the control information received by the control information receiver 211 and/or user operations such as sound volume adjustment received by the operator 260, and transmits the generated sound signals to the sound outputter 240. As just stated, the sound output controller 213 controls the sound and its volume output from the sound outputter 240.

The communicator 220 is a communication interface for performing data communication with the communication terminal 300 and comprises, for example, a radio frequency (RF) circuit, a base band (BB) circuit, a large scale integration (LSI), an antenna, and the like. The communicator 220 wireless-communicates with the communication terminal 300 via the antenna and transmits/receives various data. Here, the communicator 220 may be configured to wired-communicate with the communication terminal 300 using a USB cable, an HDMI cable, or the like.

The driver 230 comprises, for example, a gear, a motor, an actuator, and the like. The driver 230 drives movable parts of the student robot 200 according to the drive signals acquired from the controller 210. For example, the driver 230 controls the tilt of the neck of the student robot 200 so that the student robot 200 shakes his head vertically or horizontally or turns his head. Moreover, the driver 230 drives the student robot 200 to change the shape of the mouth, open/close the eyelids for blinking, or move over. With such operations and sound output described later, the student robot 200 is configured to express its feelings, line of sight, posture, and the like.

The sound outputter 240 comprises, for example, a speaker and the like. The sound outputter 240 outputs sound according to the sound signals acquired from the controller 210. Output sound is mainly sound relating to the student robot 200 learning English conversation. Sound relating to learning English conversation includes, for example, various kinds of sound proper for a student learning English conversation to utter such as answers to questions from the teacher robot 100 (including speech leading to the answers), words of joy when its own answer is correct, words of chagrin when its own answer is wrong, and words for complimenting or comforting the user depending on whether the user's answer is correct or wrong.

The storage 250 stores various data necessary for the controller 210 to control the components of the student robot 200. The storage 250 comprises, for example, a nonvolatile storage such as a flash memory and an HDD. The storage 250 stores, for example, sound data for the student robot 200 to output according to the control information received from the communication terminal 300 and the like in a given storage region.

The operator 260 comprises, for example, operation buttons, a touch panel, and the like. The operator 260 is, for example, an interface for receiving user operations such as power-on/off and output sound volume adjustment.

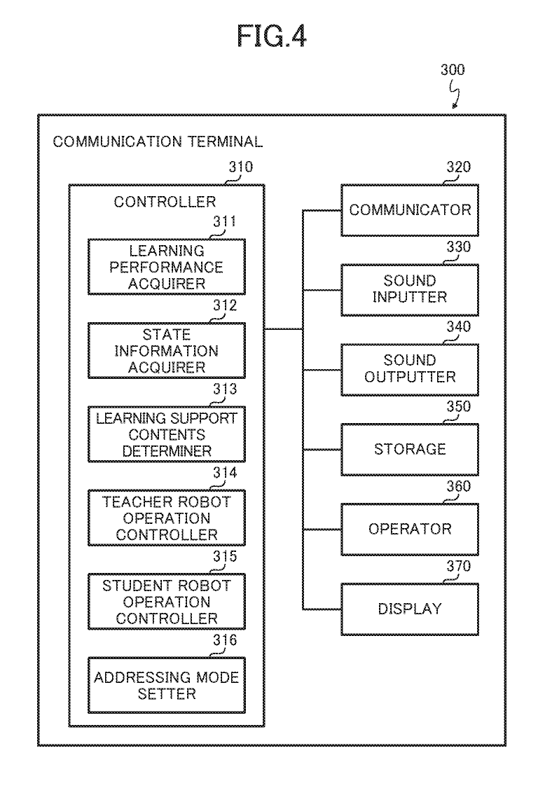

The configuration of the communication terminal 300 will be described next. As shown in FIG. 4, the communication terminal 300 comprises a controller 310, a communicator 320, a sound inputter 330, a sound outputter 340, a storage 350, an operator 360, and a display 370.

The controller 310 controls the entire operation of the communication terminal 300. The controller 310 comprises, for example, a computer having a CPU, a ROM, and a RAM. The controller 310 controls the components of the communication terminal 300 by reading and executing on the RAM various programs stored in the ROM.

The functional configuration of the controller 310 of the communication terminal 300 is described here. The controller 310 functions as a learning performance acquirer 311, a state information acquirer 312, a learning support contents determiner 313, a teacher robot operation controller 314, a student robot operation controller 315, and an addressing mode setter 316.

The learning performance acquirer 311 acquires learning performance information presenting learning performance of the user as an indicator presenting the academic ability of the user. Specifically, the learning performance acquirer 311 acquires learning performance information of the user by determining whether the user's answer to a question is correct/wrong, measuring the time taken to answer, and calculating numeric values of various elements such as the correct answer rate and the average value of the times taken to answer. The learning performance acquirer 311 saves in a learning history table described later and stores in the storage 350 the acquired learning performance information. As just stated, the learning performance acquirer 311 functions as acquirer for acquiring an indicator presenting the academic ability of the user.

The state information acquirer 312 acquires state information presenting the state of the user. The state information includes the posture, the line of sight, the facial expression, the wording, the voice tone, and the like.

The state information may further include the personality and/or the emotion of the user. This is because proper learning support contents vary depending on the personality and/or the emotion of the user. The personality of the user may be classified into, for example, four types, “active”, “composed”, “easily angered”, and “glum”, according to the degrees of sociability and stability. Moreover, the emotion of the user may be classified into, for example, four types, “delight”, “anger”, “sorrow”, and “pleasure”. The “delight” indicates the emotional state of being “delighted” and/or “happy”. The “anger” indicates the emotional state of being “angry” and/or “cranky”. The “sorrow” indicates the emotional state of being “sad” and/or “anxious”. The “pleasure” indicates the emotional state of being “composed” and/or “pleased”. It is assumed that the emotion changes according to occurrence of events.

Comprehensively taking into consideration the state information and learning curriculums, the learning support contents determiner 313 determines learning support contents to implement.

The teacher robot operation controller 314 controls the operation of the teacher robot 100. Here, the operation of the teacher robot 100 includes overall expressive actions of the teacher robot 100 such as actions of the teacher robot 100 moving movable parts such as the arms and legs (motion) and actions of uttering words (sound output). The teacher robot operation controller 314 determines, for example, necessary motion and/or sound for implementing the learning support contents determined by the learning support contents determiner 313 and controls the teacher robot 100 to execute the determined contents. In doing so, the teacher robot operation controller 314 changes the operation mode of the teacher robot 100 according to the setting details of the teacher robot setting items described later. As just stated, the teacher robot operation controller 314 functions as determiner for determining the operation of the teacher robot 100 and executor for making the teacher robot 100 execute the determined contents.

The student robot operation controller 315 controls the operation of the student robot 200. Here, the operation of the student robot 200 includes overall expressive actions of the student robot 200 such as actions of the student robot 200 moving movable parts such as the arms and legs (motion) and actions of uttering words (sound output). The student robot operation controller 315 determines, for example, necessary motion and/or sound for implementing the learning support contents determined by the learning support contents determiner 313 and controls the student robot 200 to execute the determined contents. Moreover, in controlling the operation of the student robot 200, the student robot operation controller 315 changes the operation mode of the student robot 200 according to the setting details of the student robot setting items described later. As just stated, the student robot operation controller 315 functions as determiner for determining the operation of the student robot 200 and executor for making the student robot 200 execute the determined contents.

The addressing mode setter 316 sets an addressing mode serving as a reference for determining how the student robot 200 behaves to the user. The addressing mode can include many modes. However, this embodiment is described on the assumption that the addressing mode includes two modes, a rivalry mode and a friendly mode. The rivalry mode is a mode in which the student robot 200 behaves to the user as a rival competing in the academic ability. In the rivalry mode, the student robot 200 is controlled, for example, to produce words and/or motions sounding/looking like being chagrined when the user gives an answer before the student robot 200 and/or in that case, when the user's answer is correct. Moreover, the friendly mode is a mode in which the student robot 200 behaves friendly to the user. In the friendly mode, the student robot 200 is controlled, for example, to talk to the user in a manner of inducing the user's speech when the user speaks less frequently, produce words and/or motions sounding/looking delighted when the user's answer is correct, and produce encouraging words and/or motions when the user's answer is wrong.

When either the rivalry mode or the friendly mode is selected as the addressing mode by the user via the operator 360, the addressing mode setter 316 sets the selected mode as the addressing mode. Moreover, if no addressing mode is selected by the user, the addressing mode setter 316 selects and sets a proper mode taking into consideration the contents of the state information acquired by the state information acquirer 312, the learning performance information acquired by the learning performance acquirer 311, and the like.

The communicator 320 comprises, for example, a radio frequency (RF) circuit, a base band (BB) circuit, a large scale integration (LSI), an antenna, and the like. The communicator 320 performs wireless data communication with other communication devices (for example, the teacher robot 100, the student robot 200, a not-shown access point, and the like) via the antenna. Here, the communicator 320 may be configured to wired-communicate with other devices using a USB cable, an HDMI cable, or the like.

The sound inputter 330 comprises, for example, a microphone and the like. The sound inputter 330 acquires speech of the user as sound information.

The sound outputter 340 comprises, for example, a speaker and the like. The sound outputter 340 outputs sound according to the sound signals acquired from the controller 310. Output sound includes, for example, notification sound and/or short music giving notice of switching the learning contents to implement, sound effects giving notice as to whether an answer to a question is correct or wrong, and the like. These sound data are stored in the storage 350 described later and read from the storage 350 and reproduced as appropriate.

The storage 350 stores various data necessary for the controller 310 to control the components of the communication terminal 300. The storage 350 comprises, for example, a nonvolatile storage such as a flash memory and an HDD. The storage 350 stores, for example, learning curriculums and sound data output by the communication terminal 300 in a given storage region.

Moreover, data stored in the storage 350 include a learning history table, a teacher robot operation mode setting table, a teacher robot setting items—evaluation items association table, a student robot operation mode setting table, a student robot setting items—evaluation items association table, and an evaluation item score setting table.

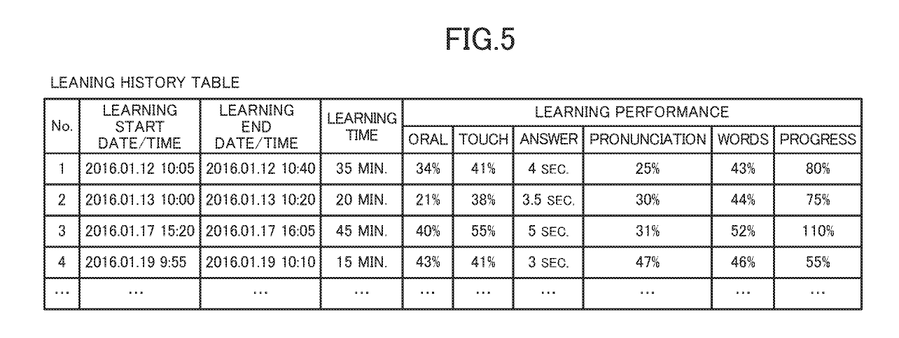

The learning history table is a table in which information of history of the user learning with the learning support system 1 is collected. In the learning history table, as shown in FIG. 5, data of “learning start date/time”, “learning end date/time”, “learning time”, and “learning performance” are associated. Here, in this embodiment, it is assumed that the user is an infant and the learning support contents are set so that the learning support implemented by the learning support system 1 lasts approximately 30 minutes per session. Moreover, the learning support contents include four basic subjects of “words” for mainly repeatedly pronouncing words and correcting the pronunciation, “sentences” for mainly repeatedly pronouncing short sentences, “chant” for mainly repeatedly pronouncing words and/or sentences in rhythm to learn pronunciation and/or intonation, “conversations” for exchanging words on familiar topics in English, and “story” for listening to short stories read out.

The “learning performance” comprises items on which the achievement in learning of the user is evaluated (evaluation items), and evaluation items “oral correct answer rate”, “touch correct answer rate”, “time taken to answer”, “pronunciation evaluation”, “word memorizing rate”, and “learning progress” are prepared. Here, in the learning history table shown in FIG. 5, the oral correct answer rate is abbreviated by “oral”; the touch correct answer rate, by “touch”; the time taken to answer, by “answer”; the pronunciation evaluation, by “pronunciation”; the word memorizing rate, by “words”; and the learning progress, by “progress”.

The “oral correct answer rate” presents the rate of correct answers by the user to questions to which the teacher robot 100 asks for answering orally. The “touch correct answer rate” presents the rate of corrects answers to questions to which the teacher robot 100 asks for answering by a touch operation. The “time taken to answer” presents the average time taken by the user to answer (orally and by touch). The “pronunciation evaluation” presents evaluation by comparison between the user's pronunciation and sample pronunciation (for example, pronunciation by a native). Here, it is assumed that data presenting sample pronunciation are prestored in the storage 150 or the like. The “word memorizing rate” presents the rate of English words the user learned and memorized (the fixing rate). The “learning progress” presents how much of the learning support contents scheduled based on the learning curriculums at the start of learning has been implemented.

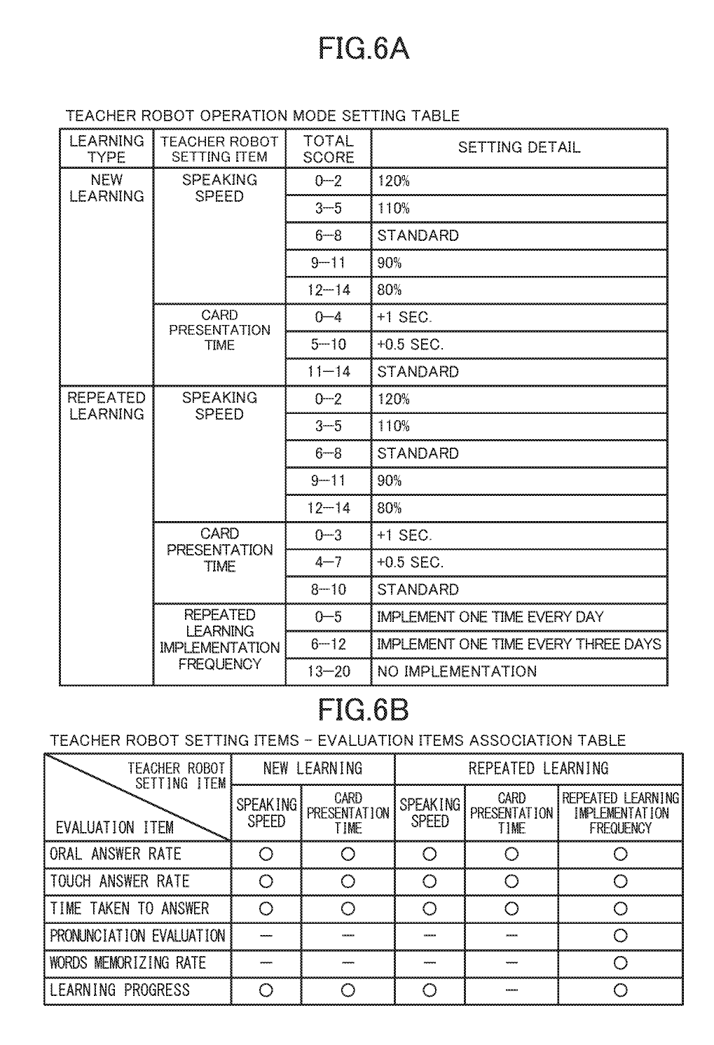

The teacher robot operation mode setting table is a table for setting a reference used for controlling the operation of the teacher robot 100 in implementing the learning support. The teacher robot operation mode setting table comprises, as shown in FIG. 6A, elements “learning type”, “teacher robot setting item”, “total score”, and “setting detail”.

Here, the “learning type” presents the type of the learning contents implemented in the learning support and is classified into “new learning” for learning new contents and “repeated learning” for reviewing contents the user has learned before.

Moreover, the “teacher robot setting item” is items for prescribing the operation mode of the teacher robot 100. The teacher robot setting items vary depending on the learning type to be implemented. Teacher robot setting items “speaking speed” and “card presentation time” are prepared for the learning type “new learning” and teacher robot setting items “speaking speed”, “card presentation time”, and “repeated learning implementation frequency” are prepared for the learning type “repeated learning”. The teacher robot setting item “speaking speed” is the reproduction speed of output sound of the teacher robot 100. The teacher robot setting item “card presentation time” is a time for which a card image relating to a question (for example, a card image used in asking a question such as asking the name of a picture, a card image for answering a multiple-choice question, a card image for giving a clue for the answer, and the like) is displayed on the display screen of the communication terminal 300. The setting item “repeated learning implementation frequency” is a frequency of implementing the repeated learning.

The “total score” is an indicator for determining the setting details of each setting item and is the total of scores on evaluation items associated with a teacher robot setting item. In the “total score” of the teacher robot operation mode setting table shown in FIG. 6A, the range of the total of the scores of the respective evaluation items is set.

The “setting detail” is a specific detail to which a setting item is set and, for example, a set value of a setting item. In this teacher robot operation mode setting table, different setting details are defined depending on the total score on a setting item.

In the teacher robot operation mode setting table shown in FIG. 6A, for example, for the teacher robot setting item “speaking speed” of the learning types “new learning” and “repeated learning”, a setting detail “120%” presenting sound output at a reproduction speed 1.2 times the standard reproduction speed is defined with respect to the total score “0 to 2”; a setting detail “110%” presenting sound output at a reproduction speed 1.1 times the standard reproduction speed, with respect to the total score “3 to 5”; a setting detail “standard” presenting sound output at the standard reproduction speed, with respect to the total score “6 to 8”; a setting detail “90%” presenting sound output at a reproduction speed 0.9 times the standard reproduction speed, with respect to the total score “9 to 11”; and a setting detail “80%” presenting sound output at a reproduction speed 0.8 times the standard reproduction speed, with respect to the total score “12 to 14”. As just stated, for the setting item “speaking speed”, the setting details are defined so that sound output is at a higher speed than the standard reproduction speed as the total score is lower while sound output is at a higher speed than the standard reproduction speed as the total score is higher. Here, different setting details (reproduction speeds) may be defined for the setting item “speaking speed” of the learning types “new learning” and “repeated learning”. For example, in order to improve reviewing effectiveness, the setting details may be defined so that sound output is overall at lower speeds for the setting item “speaking speed” of the learning type “repeated learning” than for the setting item “speaking speed” of the learning type “new learning”.

Moreover, for the teacher robot setting item “card presentation time” of the learning types “new learning” and “repeated learning”, a setting detail “+1 second” is defined with respect to the total score “0 to 4”; a setting detail “+0.5 second”, with respect to the total score “5 to 10”; and a setting detail “standard”, with respect to the total score “8 to 10”.

Here, the setting detail “standard” indicates displaying a card image on the display screen of the communication terminal 300 nearly at the same time as the start of output of sound of the teacher robot 100 reading a question (a question sound) and deleting the card image displayed on the display screen of the communication terminal 300 nearly at the same time as the end of output of the question sound, in other words presenting a card to the user for a period during which a question sound is output (an question sound output period). Moreover, the setting detail “+0.5 second” indicates displaying a card image on the display screen of the communication terminal 300 0.5 second before the start of output of a question sound and deleting the card image displayed on the display screen of the communication terminal 300 0.5 second after the end of output of the question sound, in other words presenting a card to the user for the question sound output period plus 0.5 second each before and after the period. Moreover, the setting detail “+1 second” indicates displaying a card image on the display screen of the communication terminal 300 one second before the start of output of a question sound and deleting the card image displayed on the display screen of the communication terminal 300 one second after the end of output of the question sound, in other words presenting a card the user for the question sound output period plus one second each before and after the period.

As described above, for the setting item “card presentation time”, a longer card presentation time is defined as the total score is lower in order to give the user more time to consider an answer to a question.

Here, different setting details (card presentation times) may be defined for the teacher robot setting item “card presentation time” of the learning types “new learning” and “repeated learning”. For example, taking into consideration the user having learned before, the setting details may be defined so that card presentation times are overall shorter for the setting item “card presentation time” of the learning type “repeated learning” than for the setting item “card presentation time” of the learning type “new learning”.

Moreover, for the teacher robot setting item “repeated learning implementation frequency” of the learning type “repeated learning”, a setting detail “implement one time every day” indicating implementing repeated learning for reviewing contents the user has learned before one time every day is defined with respect to the total score “0 to 5”; a setting detail “implement one time every three days” indicating implementing repeated learning one time every three days, with respect to the total score “6 to 12”; and a setting detail “no implementation” indicating not implementing repeated learning, with respect to the total score “13 to 20”. As just stated, for the setting item “repeated learning implementation frequency”, the setting details are defined so that the frequency of implementing repeated learning is higher as the score is lower and the frequency of implementing repeated learning is lower as the score is higher.

The teacher robot setting items—evaluation items association table is a table in which the association between the “teacher robot setting item” and “evaluation item”. is defined. In the teacher robot setting items—evaluation items association table shown in FIG. 6B, evaluation items having “0” under each teacher robot setting item are the evaluation items associated with that teacher robot setting item.

Here, the “teacher robot setting item” is the same as the “teacher robot setting item” in the teacher robot operation mode setting table described earlier. Moreover, the “evaluation item” is items for evaluating the achievement in learning of the user and the like and the same as the “learning performance” in the learning history table described earlier.

The total score on a teacher robot setting item is calculated by adding the scores on the evaluation items associated with that teacher robot setting item. Moreover, as described earlier in regard to the teacher robot operation mode setting table, the setting details of a teacher robot setting item are determined according to the total score on that teacher robot setting item. As just stated, the scores on evaluation items associated with a teacher robot setting item are reflected in determining the setting detail of that teacher robot setting item. Here, the scores on evaluation items are assigned according to the evaluation values of the evaluation items in the evaluation item score setting table described later.

For example, in the teacher robot setting items—evaluation items association table shown in FIG. 6B, evaluation items “oral correct answer rate”, “touch correct answer rate”, “time taken to answer”, and “learning progress” are associated with the teacher robot setting item “speaking speed” of the “new learning”. In other words, the total score on the teacher robot setting item “speaking speed” is the total of the scores on the evaluation items “oral correct answer rate”, “touch correct answer rate”, “time taken to answer”, and “learning progress”.

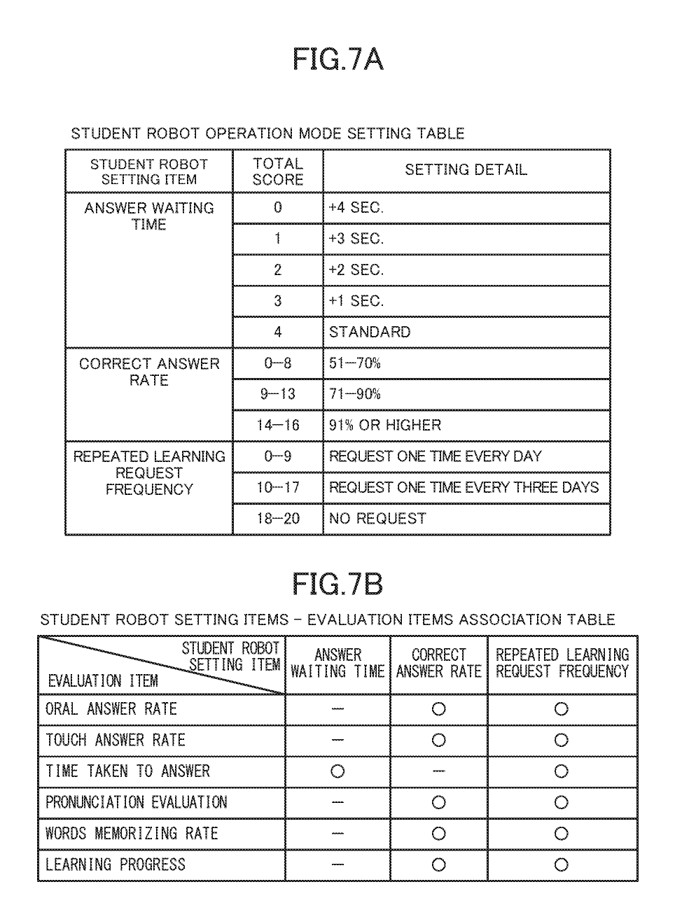

The student robot operation mode setting table is a table for setting a reference used for controlling the operation of the student robot 200 in implementing learning support. In the student robot operation mode setting table, as shown in FIG. 7A, elements “student robot setting item”, “total score”, and “setting detail” are associated.

The “student robot setting item” is items for prescribing the operation mode of the student robot 200, and “answer waiting time”, “correct answer rate”, and “repeated learning request frequency” are prepared. Here, in the student robot operation mode setting table shown in FIG. 7A, unlike the teacher robot operation mode setting table described earlier, the same student robot setting items are defined regardless of whether the learning type is “new learning” or “repeated learning.” Here, also in the student robot operation mode setting table, as in the teacher robot operation mode setting table, the student robot setting items may be defined for each learning type so as to control the operation of the student robot 200 according to the learning type to implement.

The student robot setting item “answer waiting time” presents a time for the student robot 200 to wait before answering (oral answering and touch answering) a question from the teacher robot 100. The student robot setting item “correct answer rate” presents a rate of the student robot 200 giving a correct answer to a question. The student robot setting item “repeated learning request frequency” presents a frequency of the student robot 200 requesting implementation of repeated learning. The student robot 200 requests implementation of repeated learning of the teacher robot 100 by, for example, outputting sound such as “Let's do the xx (learning content) we did before again”.

The “total score” is an indicator for determining the setting details of each setting item and is the total of scores on evaluation items associated with a student robot setting item. In the “total score” of the teacher robot operation mode setting table shown in FIG. 7A, the total of the scores of the respective evaluation items or the range thereof is set.

The “setting detail” is a specific detail to which a setting item is set and, for example, a set value of a setting item. In this student robot operation mode setting table, different setting details are defined depending on the total score on a setting item.

As shown in FIG. 7A, for the student robot setting item “answer waiting time”, a setting detail “+4 seconds” indicating that after a question is given by the teacher robot 100, the student robot 200 waits for a given standard time plus four seconds before answering is defined with respect to the total score “0”; a setting detail “+3 seconds” indicating that after a question is given by the teacher robot 100, the student robot 200 waits for a given standard time plus three seconds before answering, with respect to the total score “1”; a setting detail “+2 seconds” indicating that after a question is given by the teacher robot 100, the student robot 200 waits for a given standard time plus two seconds before answering, with respect to the total score “2”; a setting detail “+1 second” indicating that after a question is given by the teacher robot 100, the student robot 200 waits for a given standard time plus one second before answering, with respect to the total score “3”; and a setting detail “standard” indicating that after a question is given by the teacher robot 100, the student robot 200 waits for a given standard time (for example, two seconds) before answering, with respect to the total score “4”. As just stated, for the student robot setting item “answer waiting time”, the setting details are defined so that the student robot 200 answers more slowly as the total score is lower and the student robot 200 answers more quickly as the total score is higher.

Moreover, for the student robot setting item “correct answer rate”, a setting detail “51 to 70%” is defined with respect to the total score “0 to 8”; a setting detail “71 to 90%”, with respect to the total score “9 to 13”; and a setting detail “91% or higher”, with respect to the total score “14 to 16”. Here, each setting detail presents a rate of selecting a correct answer from among multiple probable answers. For example, when the setting detail is “51 to 70%”, a correct answer is selected as an answer of the student robot 200 from among multiple probable answers at a rate of 51 to 70%. As just stated, for the student robot setting item “correct answer rate”, the setting details are defined so that the correct answer rate of the student robot 200 is lower as the total score is lower and the correct answer rate of the student robot 200 is higher as the total score is higher.

Moreover, for the student robot setting item “repeated learning request frequency”, a setting detail “request one time every day” indicating requesting repeated learning for reviewing contents the user has learned before one time every day is defined with respect to the total score “0 to 9”; a setting detail “request one time every three days” indicating requesting repeated learning one time every three day, with respect to the total score “10 to 17”; and a setting detail “no request” indicating not requesting repeated learning, with respect to the total score “18 to 20”. As just stated, for the student robot setting item “repeated learning request frequency”, the setting details are defined so that the frequency of the student robot 200 requesting repeated learning is higher as the total score is lower and the frequency of the student robot 200 requesting repeated learning is lower as the total score is higher. Here, when repeated learning is requested by the student robot 200, the teacher robot 100 implements repeated learning in response to the request as needed.

The student robot setting items—evaluation items association table is a table in which the association between the “student robot setting item” and “evaluation item” is defined. In the student robot setting items—evaluation items association table shown in FIG. 7B, evaluation items having “0” under each student robot setting item are the evaluation items associated with that student robot setting item.

Here, the “student robot setting item” is the same as the “student robot setting item” in the student robot operation mode setting table described earlier. Moreover, the “evaluation item” is items for evaluating the achievement in learning of the user and the like and the same as the evaluation items constituting the “learning performance” in the learning history table described earlier.

The total score on a student robot setting item is calculated by, like the total score on a teacher robot setting item, adding the scores on the evaluation items associated with that student robot setting item. Moreover, as described earlier in regard to the student robot operation mode setting table, the setting details of a student robot setting item are determined according to the total score on that student robot setting item. As just stated, the scores on evaluation items associated with a student robot setting item are reflected in determining the setting details of that student robot setting item. Here, the scores on evaluation items are assigned according to the evaluation values of the evaluation items in the evaluation item score setting table described later.

For example, in the student robot setting items—evaluation items association table shown in FIG. 7B, an evaluation item “time taken to answer” is associated with the student robot setting item “answer waiting time”. In other words, the total score on the student robot setting item “answer waiting time” is the score on the evaluation item “time taken to answer”. With such association, the answering timing of the student robot 200 can directly be changed according to the time taken by the user to answer. In other words, it is possible to control the operation of the student robot 200 in accordance with the ability of the user.

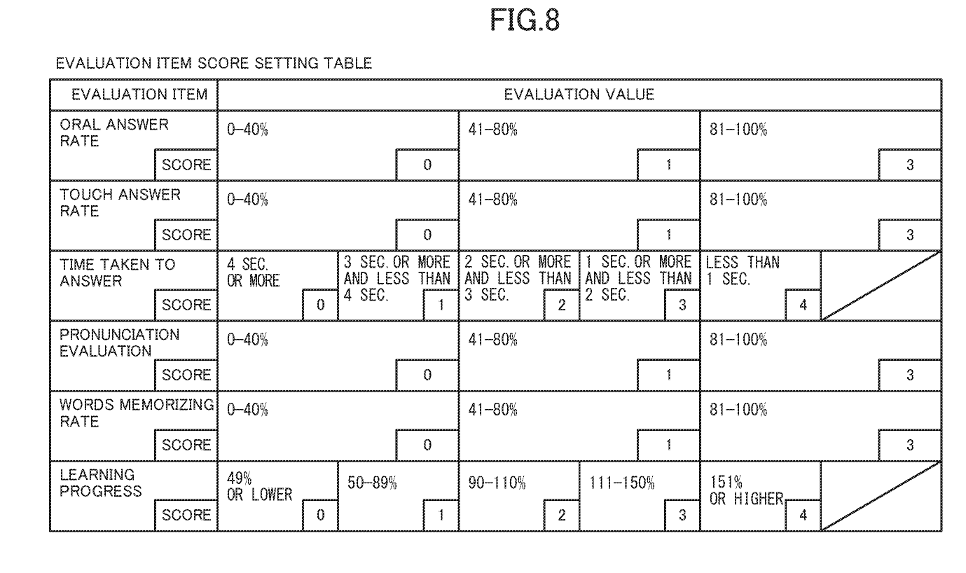

The evaluation item score setting table is a table in which scores to assign according to the evaluation values of the evaluation items are set. In the evaluation item score setting table, as shown in FIG. 8, elements “evaluation item”, “evaluation value”, and “score” are associated.

The “evaluation item” is the same as evaluation items constituting the “learning performance” in the learning history table described earlier. The “evaluation value” refers to specific details of the evaluation item and, for example, numerical values or degrees of the evaluation item. The “score” is scores assigned according to the evaluation values of the evaluation item.

In the evaluation item score setting table, for example, for the evaluation item “oral correct answer rate”, a score “0” is assigned to the evaluation value “0 to 40%”; a score “1”, to the evaluation value “41 to 80%”; and a score “3”, to the evaluation value “81 to 100%”. Moreover, for the evaluation item “learning progress rate”, a score “0” is assigned to the evaluation value “49% and lower”; a score “1”, to the evaluation value “50 to 89%”; a score “2”, to the evaluation value “90 to 110%”; a score “3”, to the evaluation value “111 to 150%”; and a score “4”, to the evaluation value “151% or higher”. As just stated, in the evaluation item score setting table, a higher score is assigned as the evaluation value of an evaluation item is higher while a lower score is assigned as the evaluation value of an evaluation item is lower.

The operator 360 comprises, for example, operation buttons, a touch panel, and the like. The operator 360 is, for example, an interface for receiving user operations such as learning start or end, selection of an addressing mode, and input of an answer to a question.

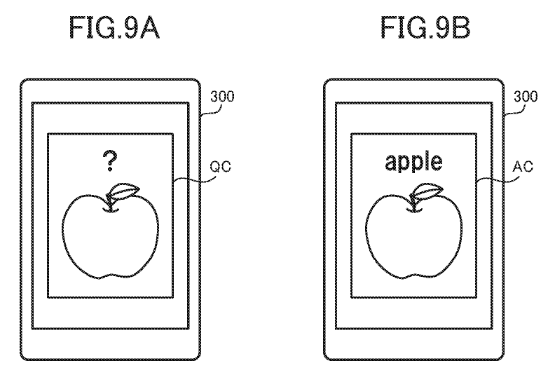

The display 370 comprises, for example, a liquid crystal display (LCD), an electroluminescence (EL) display, or the like and displays images according to image data entered by the controller 310. The display 370 displays on the display screen, for example, card images used, for example, in a question of asking the name of a picture shown in FIGS. 9A and 9B. FIG. 9A shows a card image QC displayed on the display screen in presenting a question and FIG. 9B shows a card image AC displayed on the display screen in showing an answer. Here, a symbol “O (correct answer)” or “X (wrong answer)” presenting whether the user's answer is correct or wrong may be displayed in FIG. 9B.

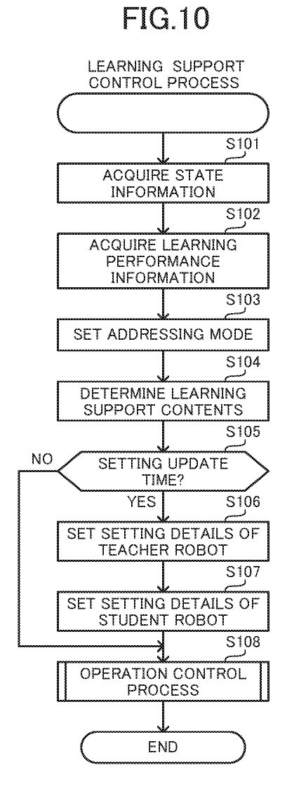

The learning support control process executed by the controller 310 of the communication terminal 300 will be described next with reference to the flowchart shown in FIG. 10. The learning support control process is a process to determine learning support contents based on academic ability information and state information of the user and implement learning support corresponding to the determined learning support contents. Moreover, the learning support control process includes the operation control process to control the operations of the teacher robot 100 and the student robot 200.

The controller 310 starts the learning support control process in response to the operator 360 receiving a learning start order operation by the user. As the learning support control process starts, the state information acquirer 312 of the controller 310 acquires state information (Step S101).

Specifically, the state information acquirer 312 makes the imager 170 of the teacher robot 100 capture a still image or a video presenting the posture, the line of sight, the facial expression, and/or the like of the user and makes the communicator 120 transmit image data of the captured still image or video. Then, the state information acquirer 312 performs image recognition on the image data of the still image or the video acquired via the communicator 320. As a result, the state information acquirer 312 acquires as state information the emotion and the like of the user from the viewpoint of whether the user has a good posture and/or a stable line of sight and/or how his eyes are opened.

Moreover, the state information acquirer 312 of the controller 310 makes the sound inputter 330 acquire sound data presenting the contents of speech of the user and performs voice recognition on the sound data. As a result, the state information acquirer 312 of the controller 310 acquires as state information the wording, the voice tone, and/or the like in answering of the user.

Then, the learning performance acquirer 311 of the controller 310 acquires learning performance information (Step S102). The learning performance acquirer 311 reads the learning history table stored in the storage 350 and acquires as learning performance information learning performance data in the learning history table.

Subsequently, the addressing mode setter 316 of the controller 310 sets an addressing mode (Step S103). When an addressing mode selection operation by the user is received via the operator 360, the addressing mode setter 316 sets the selected one of the rivalry mode and the friendly mode as the addressing mode. On the other hand, when an addressing mode selection operation by the user is not received, comprehensively taking into consideration various data included in the state information and/or the learning performance information, the addressing mode setter 316 sets as the addressing mode one of the rivalry mode and the friendly mode that is determined to be proper. For example, the addressing mode setter 316 sets the rivalry mode as the addressing mode when there are many data indicating that the user has a high motivation to learn (for example, data showing seemingly having fun, a high correct answer rate, and the like). On the other hand, the addressing mode setter 316 sets the friendly mode as the addressing mode when there are many data indicating that the user has a poor motivation to learn (for example, data showing a tendency of getting depressed, a low correct answer rate, and the like).

Subsequently, the learning support contents determiner 313 of the controller 310 determines learning support contents to implement this time (Step S104). In doing so, the learning support contents determiner 313 determines learning support contents to implement this time comprehensively taking into consideration various data included in the state information and/or the learning performance information, presets learning curriculums, and the like. For example, when there are many data indicating excellent learning performance (for example, data indicating a high correct answer rate, rapid learning progress, and the like), the learning support contents determiner 313 determines learning support contents so as to mix in subjects other than the above-described basic subjects as appropriate (for example, “conversation” in which free English conversation takes place with no topic fixed). On the other hand, when there are many data indicating poor learning performance (for example, data indicating a low correct answer rate, slow learning progress, and the like), the learning support contents determiner 313 determines learning support contents so as to implement a relatively approachable subject “chant” for a longer time than other subjects or prior to other subjects for increasing the user's motivation to learn.

Then, the controller 310 determines whether it is a setting update time to update the setting items of the teacher robot 100 and the student robot 200 (Step S105). The setting update time is a time after a given length of time (for example, one week) has elapsed since the setting details of the setting items of the teacher robot 100 and the student robot 200 are updated last time. If determined that it is not a setting update time (Step S105; NO), the controller 310 advances the processing to Step S108.

On the other hand, if determined that it is a setting update time (Step S105; YES), the teacher robot operation controller 314 of the controller 310 determines the setting details of the teacher robot setting items of the teacher robot 100 and sets the determined setting details (Step S106). The teacher robot operation controller 314 calculates the averages of the evaluation values of the evaluation items that are learning performance from the last update date to the last learning date with reference to the learning history table. The teacher robot operation controller 314 acquires the scores on the evaluation items corresponding to the calculated averages of the evaluation values with reference to the evaluation item score setting table. Moreover, the teacher robot operation controller 314 determines a setting detail for each item of the teacher robot setting items with reference to the teacher robot setting items—evaluation items association table and the teacher robot operation mode setting table. Then, the teacher robot operation controller 314 sets the determined setting detail for each item of the teacher robot setting items.

Subsequently, the student robot operation controller 315 of the controller 310 determines the setting details of the student robot setting items of the student robot 200 and sets the determined setting details (Step S107). The student robot operation controller 315 calculates the averages of the evaluation values of the evaluation items that are learning performance from the last update date to the last learning date with reference to the learning history table. Here, the student robot operation controller 315 may borrow the averages of the evaluation values of the evaluation items calculated by the teacher robot operation controller 314 in the Step S106. Then, the student robot operation controller 315 acquires the scores on the evaluation items corresponding to the calculated averages of the evaluation values with reference to the evaluation item score setting table. Moreover, the student robot operation controller 315 determines a setting detail for each item of the student robot setting items with reference to the student robot setting items—evaluation items association table and the student robot operation mode setting table. Then, the student robot operation controller 315 sets the determined setting detail for each item of the student robot setting items.

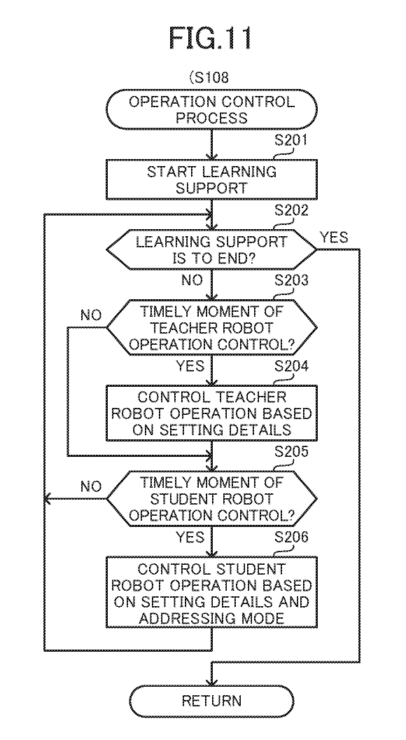

After executing the processing of the Step S107, or when NO is determined in the Step S105, the controller 310 executes the operation control process (Step S108). The operation control process is described here with reference to the flowchart shown in FIG. 11. The operation control process is a process to control the operations of the teacher robot 100 and the student robot 200 while the learning support is implemented.

As the operation control process starts, the controller 310 starts learning support according to the learning support contents determined in the Step S104 (Step S201). In doing so, for example, the controller 310 controls the sound outputter 340 to output announcement to give notice of start of learning support (for example, a notifying sound to give notice of start of learning support or voice such as “Let's start learning”).

Subsequently, the controller 310 determines whether to end the learning support (Step S202). The controller 310 determines whether to end the learning support according to whether the operator 360 has received a learning end order operation by the user or whether the learning support contents scheduled to implement this time are all implemented. When determined to end the learning support (Step S202; YES), the controller 310 ends the operation control process.

On the other hand, if determined to continue the learning support (Step S202; NO), the teacher robot operation controller 314 of the controller 310 determines whether it is a timely moment of teacher robot operation control (Step S203). Here, a timely moment of teacher robot operation control is among general timely moments of triggering an operation of the teacher robot 100 in implementing the learning support, such as a timely moment of making the teacher robot 100 output sound of reading a question or a timely moment of driving and making some movable parts of the teacher robot 100 operate according to whether the answer of the user or the student robot 200 is correct or wrong. If determined that it is not a timely moment of teacher robot operation control (Step S203; NO), the controller 310 advances the processing to Step S205.

On the other hand, if determined that it is a timely moment of teacher robot operation control (Step S203; YES), the teacher robot operation controller 314 controls the operation of the teacher robot 100 (Step S204). Specifically, the teacher robot operation controller 314 determines an operation for the teacher robot 100 to execute according to the setting details of the teacher robot setting items and transmits control information for giving an order to execute the determined contents to the teacher robot 100 to control the operation of the teacher robot 100. For example, in making the teacher robot 100 output sound of reading a question, when the setting detail of the setting item “speaking speed” is “80%”, the teacher robot operation controller 314 generates control information for giving an order to output sound of reading the question at a reproduction speed 0.8 times the standard reproduction speed, and transmits the control information to the teacher robot 100. The teacher robot 100 having received the control information reads sound data of the specified question from the storage 150 and reproduces sound of reading the question at a reproduction speed 0.8 times the standard reproduction speed according to the control information. Moreover, the teacher robot operation controller 314 generates control information for giving an order to drive some movable parts of the teacher robot 100 based on the result of determination by the learning performance acquirer 311 as to whether the user's answer to the question is correct or wrong, and transmits the control information to the teacher robot 100. The teacher robot 100 having received the control information executes a given operation by controlling the driver 230 according to the control information.

Subsequently, the student robot operation controller 315 of the controller 310 determines whether it is a timely moment of student robot operation control (Step S205). Here, a timely moment of student robot operation control is among general timely moments of triggering an operation of the student robot 200 in implementing the learning support, such as a timely moment of making the student robot 200 output sound of answering a question or a timely moment of driving and making some movable parts of the student robot 200 operate. If determined that it is not a timely moment of student robot operation control (Step S205; NO), the controller 310 returns the processing to the Step S202.

On the other hand, if determined that it is a timely moment of student robot operation control (Step S205; YES), the student robot operation controller 315 controls the operation of the student robot 200 (Step S206). Specifically, the student robot operation controller 315 determines an operation for the student robot 200 to execute according to the setting details of the student robot setting items and the addressing mode and transmits control information for giving an order to execute the determined contents to the student robot 200 to control the operation of the student robot 200.

For example, in making the student robot 200 output sound of answering a question, when the setting detail of the setting item “answer waiting time” is “+3 seconds” and the setting detail of the student robot setting item “correct answer rate” is “51 to 70%”, the student robot operation controller 315 generates control information for giving an order to select an answer from among multiple probable answers at a correct answer selection rate of 51 to 70% and output sound of the selected answer after waiting for a given standard time plus three seconds since a question is given by the teacher robot 100, and transmits the control information to the student robot 200. The student robot 200 having received this control information reads sound data of the specified answer from the storage 150 and reproduces sound of the answer with the specified timing according to the control information.

Moreover, for example, when the user has given a correct answer before the student robot 200 and the addressing mode is the rivalry mode, the student robot operation controller 315 generates control information for giving an order to output sound of contents sounding like being chagrined and transmits the control information to the student robot 200. The student robot 200 having received the control information reads from the storage 150 and reproduces the specified sound data according to the control information.

After executing the processing of the Step S206, the controller 310 returns the processing to the Step S202 and repeats the processing of the Steps S203 to S206 until ending the learning support (until YES is determined in the Step S202).

As described above, according to this embodiment, the communication terminal 300 controls the operation of the student robot 200 based on the setting details of the student robot setting items that are set based on the results of evaluation on the learning performance of the user and prescribe the operation mode of the student robot 200. As a result, the communication terminal 300 can make the student robot 200 produce proper words and/or movements to the user. Thus, the communication terminal 300 can support the user in learning properly in accordance with his academic ability.

Furthermore, the student robot 200 is controlled by the communication terminal 300 in operation with respect to the user based on the addressing mode set based on the selection by the user or the results of evaluation on the learning performance of the user and serving as a reference for how to behave to the user. As a result, the student robot 200 can be made to act as a student learning with the user according to the user's request or the user's academic ability. As a result, it is possible to increase the user's motivation to learn.

Moreover, according to this embodiment, the communication terminal 300 controls the operation of the teacher robot 100 based on the setting details of the teacher robot setting items that are set based on the results of evaluation on the learning performance of the user and prescribe the operation mode of the teacher robot 100. As a result, the communication terminal 300 can make the teacher robot 100 produce proper words and/or movements to the user. Thus, the communication terminal 300 can support the user in learning properly in accordance with his academic ability.

The present disclosure is not confined to the above embodiment and various changes and applications are available. The above-described embodiment can be modified as follows.

In the above-described embodiment, the controller 310 of the communication terminal 300 collectively controls the operations of the teacher robot 100 and the student robot 200. However, a control device independent from the teacher robot 100, the student robot 200, and the communication terminal 300 may control the operations of the teacher robot 100 and the student robot 200. Moreover, the teacher robot 100 and the student robot 200 may be communicably connected and support the user in learning in a mutually collaborative manner.

In the above-described embodiment, the learning support system 1 comprises the teacher robot 100, the student robot 200, and the communication terminal 300. However, the learning support system according to the present disclosure is not confined to such a configuration.

For example, the learning support system 1 may comprise a problems output device provided with the function of teaching in place of the teacher robot 100 and the communication terminal 300. In such a case, it may be possible that the problems output device presents questions to the user and the student robot 200 and the student robot 200 answers the questions based on the student robot setting items and/or the addressing mode.

Moreover, the above-described embodiment may be realized by the student robot 200 only. For example, three-party learning involving a teacher and a learner as users and the student robot 200 may take place. In such a case, the student robot 200 may additionally comprise the function possessed by the communication terminal 300 and respond to speech of the teacher and the learner.

Moreover, the above-described embodiment may be realized by the teacher robot 100 only. For example, two-party learning involving a learner as a user and the teacher robot 100 may take place. In such a case, the teacher robot 100 may additionally comprise the function possessed by the communication terminal 300 and respond to speech of the learner. Furthermore, multiple learners may, as users, use the teacher robot 100 for learning.

In the above-described embodiment, the learning performance acquirer 311 of the communication terminal 300 acquires learning performance information presenting learning performance of the user such as the correct answer rate and the time taken to answer as an indicator presenting the academic ability of the user. However, this is not restrictive and the learning performance acquirer 311 may acquire, in place of or in addition to the learning performance information, information with which the user's academic ability can be evaluated such as various data presenting the user's knowledge and/or skill, his ability to think and/or express for solving problems using his knowledge and/or skill, and his motivation and/or attitude for learning.

In the above-described embodiment, the operation program executed by the CPU of the controller 310 is prestored in the ROM or the like. However, the present disclosure is not restricted thereto and the operation program for executing the above-described various processes may be loaded on an existing general-purpose computer, a framework, a work station, or the like so as to make them function as a device corresponding to the communication terminal 300 according to the above-described embodiment.

Such a program can be provided by any method and, for example, may be saved and distributed on a non-transitory computer-readable recording medium (a flexible disc, a compact disc (CD)-ROM, or a digital versatile disc (DVD)-ROM) or the like, or may be provided by saving in a storage on a network such as the Internet and downloading the program.

Moreover, when the above-described processes are executed by apportionment between an operating system (OS) and an application program or cooperation of an OS and an application program, only the application program may be saved on a non-transitory recording medium or in a storage. Moreover, the program can be superimposed on carrier waves and distributed via a network. For example, the above-described program may be posted on a bulletin board system (BBS) on a network and distributed via the network. Then, the program may be activated and executed in a manner similar to other application programs under the control of an OS so that the above-described processes are executed.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A robot control device for controlling a student robot playing a role of a student learning with a user, the robot control device comprising:
an acquirer that acquires an indicator presenting academic ability of the user;
a determiner that determines an operation of the student robot based on the indicator presenting the academic ability of the user acquired by the acquirer; and
an executor that makes the student robot execute the operation determined by the determiner.

2. The robot control device according to claim 1, wherein
the determiner sets a reference for controlling the operation of the student robot based on the indicator presenting the academic ability of the user acquired by the acquirer and determines the operation of the student robot according to the set reference.

3. The robot control device according to claim 2, wherein
the reference comprises multiple setting items prescribing the operation of the student robot, and
the determiner sets the reference by determining details of the multiple setting items.

4. The robot control device according to claim 3, wherein
the determiner sets setting details of the multiple setting items based on evaluation values of multiple evaluation items included in the indicator presenting the academic ability of the user.

5. The robot control device according to claim 3, wherein
the multiple setting items include an item prescribing a mode of the student robot answering questions.

6. The robot control device according to claim 2, wherein
the acquirer acquires state information presenting a state of the user in addition to the indicator presenting the academic ability of the user, and
the determiner sets the reference based on the indicator presenting the academic ability of the user and the state information acquired by the acquirer.

7. The robot control device according to claim 1, further comprising:
a state information acquirer that acquires state information presenting a state of the user; and
a learning support contents determiner that determines learning support contents,
wherein the learning support contents determiner determines, based on the state information acquired by the state information acquirer , the learning support contents to improve the academic ability of the user relative to a current academic ability , and
the determiner determines the operation of the student robot based on the indicator presenting the academic ability of the user and the learning support contents .

8. The robot control device according to claim 1, wherein
the acquirer acquires learning performance information presenting learning performance of the user as the indicator presenting the academic ability of the user.

9. A robot control device for controlling a robot supporting a user in learning, the robot control device comprising:
an acquirer that acquires an indicator presenting academic ability of the user;
a determiner that determines an operation of the robot based on the indicator presenting the academic ability of the user acquired by the acquirer; and
an executor that makes the robot execute the operation determined by the determiner.

10. The robot control device according to claim 9, wherein
the determiner sets a reference for controlling the operation of the robot based on the indicator presenting the academic ability of the user acquired by the acquirer and determines the operation of the robot according to the set reference.

11. The robot control device according to claim 10, wherein
the reference comprises multiple setting items for controlling the robot as a teacher robot playing a role of a teacher teaching the user, and
the determiner sets the reference by determining details of the multiple setting items.

12. The robot control device according to claim 11, wherein
the determiner sets setting details of the multiple setting items based on evaluation values of multiple evaluation items included in the indicator presenting the academic ability of the user.

13. The robot control device according to claim 11, wherein
the multiple setting items include an item prescribing a teaching mode of the robot .

14. The robot control device according to claim 9, wherein
the acquirer acquires learning performance information presenting learning performance of the user as the indicator presenting the academic ability of the user.

15. A student robot comprising:
the robot control device according to claim 1,
wherein the student robot is controlled by the robot control device.

16. A teacher robot comprising:
the robot control device according to claim 9,
wherein the teacher robot is controlled by the robot control device.

17. A learning support system for implementing learning support for a user, the learning support system comprising:
the robot control device according to claim 9;
a student robot that is controlled by the robot control device to act as a student learning with a user; and
a teacher robot that is controlled by the robot control device to act as a teacher teaching the user.

18. A robot control method of controlling a student robot playing a role of a student learning with a user, the robot control method comprising:
acquiring an indicator presenting academic ability of the user;
determining an operation of the student robot based on the acquired indicator presenting the academic ability of the user; and
making the student robot execute the determined operation.
